(19) United States
(12) Patent Application Publication
(10) Pub. No.: US 2009/0077322 A1
(43) Pub. Date: Mar. 19, 2009

(54) System and Method for Getllar Hit Cache Line Data Forward Via Data-Only Transfer Protocol Through BEB Bus

(76) Inventors: Charles Ray Johns, Austin, TX (US); Roy Moonseuk Kim, Austin, TX (US); Peichun Peter Liu, Austin, TX (US); Shigehiro Asano, Austin, TX (US); Anushkumar Rengarajan, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/857,674

(22) Filed: Sep. 19, 2007

(51) Int. Cl. G06F 12/08

(52) U.S. Cl. 711/141; 711/E12.02

(57) ABSTRACT

A system and method for using a data-only transfer protocol to store atomic cache line data in a local storage area is presented. A processing engine includes an atomic cache and a local storage. When the processing engine encounters a request to transfer cache line data from the atomic cache to the local storage (e.g., GETTLAR command), the processing engine utilizes a data-only transfer protocol to pass cache line data through the external bus node and back to the processing engine. The data-only transfer protocol comprises a data phase and does not include a prior command phase or snoop phase due to the fact that the processing engine communicates to the bus node instead of an entire computer system when the processing engine sends a data request to transfer data to itself.

### BACKGROUND OF THE INVENTION

1. Technical Field

The present invention relates to a system and method for using a data-only transfer protocol to store atomic cache line data in a local storage area. More particularly, the present invention relates to a system and method for a processing engine to use a data-only transfer protocol in conjunction with an external bus node to transfer data from an internal atomic cache to an internal local storage area.

2. Description of the Related Art

A computer system comprises a processing engine that includes an atomic cache. The processing engine uses the atomic cache for tasks that are dependent upon the atomicity of cache line accesses that require read cache line data and write cache line data without interruption, such as processor synchronization (e.g., semaphore utilization).

In a large symmetrical multi-processor system, the system typically uses a lock acquisition to synchronize access to data structures. Systems that run with producer-consumer application types have to ensure that the produced data is globally visible before allowing consumers to access the produced data structure. Usually, the producer attempts to acquire a lock using a lock-load instruction, such as a “Getllar” command, and verifies the acquisition on a lock-word value. The “Getlar” command has a transfer size of one cache line, and the command executes immediately instead of being queued in the processing engine's DMA command queue like other DMA commands. Once the producer application has acquired the lock, the producer application becomes the owner of the data structure until it releases the lock. In turn, the consumer waits for the lock release before accessing the data structure.

When attempting to acquire a lock, software “spins” or loops on an atomic update sequence that executes the Getllar instruction and compares the data with a software specific definition indicating “lock_free.” If the value is “not free,” the software branches back to the Getllar instruction to restart the sequence. When the value indicates “free,” the software exits the loop and uses a conditional lock_store instruction to update the lock word to “lock taken.” The conditional lock_store fails when the processor that is attempting to acquire the lock no longer holds the reservation. When this occurs, the software again restarts the loop beginning with the Getllar instruction. A challenge found is that this spin loop causes the same data to be retrieved out of cache over and over when the lock is taken by another processing element.

What is needed, therefore, is a system and method that reduces latency for DMA requests corresponding to atomic cache lines.

### SUMMARY

It has been discovered that the aforementioned challenges are resolved using a system and method for a processing engine to use a data-only transfer protocol in conjunction with an external bus node to transfer data from an internal atomic cache to an internal local storage area. When the processing engine encounters a request to transfer cache line data from the atomic cache to the local storage (e.g., GETTLAR command), the processing engine utilizes a data-only transfer protocol to pass cache line data through the external bus node and back to the processing engine. The data-only transfer protocol comprises a data phase without a command phase or a snoop phase.

A processing engine identifies a direct memory access (DMA) command that corresponds to a cache line located in the atomic cache. As such, the processing engine sends a data request to an external bus node controller that, in turn, sends a data grant back to the processing engine when the bus node controller determines that an external broadband data bus is inactive. In addition, the bus node controller configures a bus node's external multiplexer to receive data from the processing engine instead of receiving data from an upstream bus node.

When the processing engine receives the data grant from the bus node controller, the processing engine transfers the cache line data from the atomic cache to the bus node. In turn, the bus node feeds the cache line data back to the processing engine without delay and the processing engine stores the cache line data in its local storage area.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a processing engine using prior art to transfer data from an atomic cache to a local storage area through an internal multiplexer;

FIG. 2 is a diagram showing a processing engine using the invention described herein to transfer data from its internal atomic cache to its internal local storage area through an external bus node;

FIG. 3 is a flowchart showing steps taken in prior art proceeding through a command phase, a snoop phase, and a data phase in order for a master device to send data to a slave device without using a data-only protocol;

FIG. 4 is a flowchart showing steps taken in a master device sending data to itself through a bus node using a data-only protocol;

FIG. 5 is a flowchart showing steps taken in a processing engine identifying an atomic cache line request and using a data-only protocol to send data to itself through a bus node;

FIG. 6 is a flowchart showing steps taken in a bus node receiving data from a processing engine and sending the data back to the processing engine using a data-only protocol;

FIG. 7 is a block diagram of an information handling system capable of implementing the present invention; and

FIG. 8 is another block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

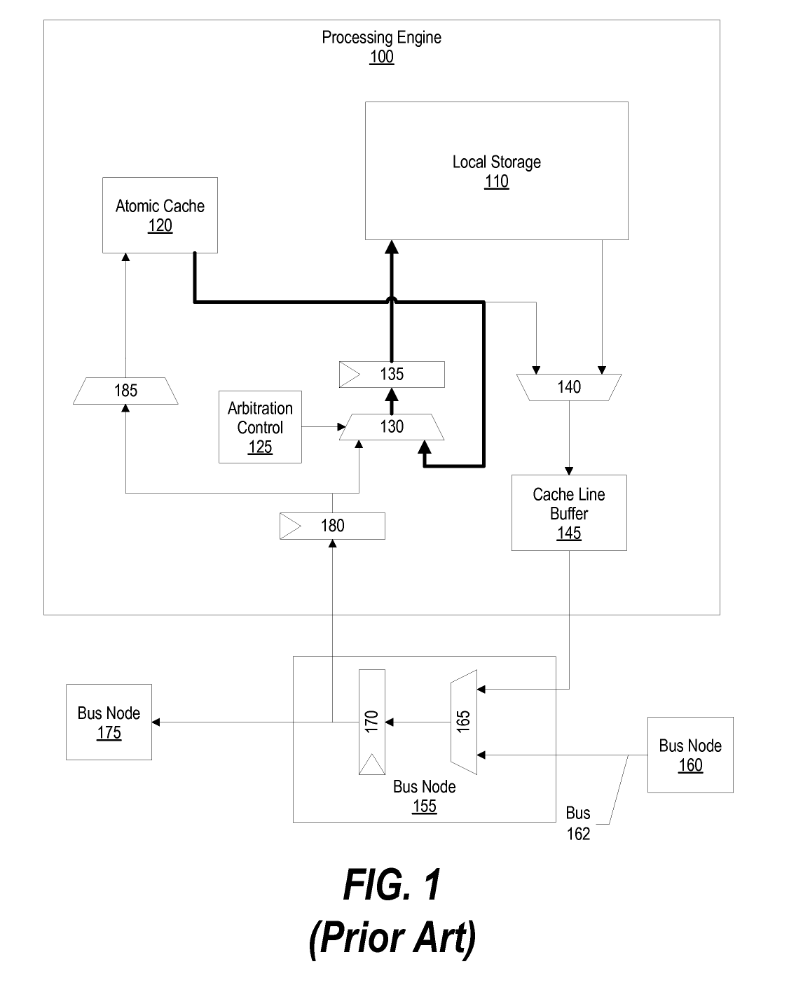

FIG. 1 is a diagram showing a processing engine using prior art to transfer data from an atomic cache to a local storage area through an internal multiplexer. Processing engine 100 includes atomic cache 120 and local storage 110. Processing engine uses internal multiplexer 140 to select between data from atomic cache 120 and local storage 110 to pass to cache line buffer 145, which subsequently passes the data externally to bus node 155. Bus node 155 receives bus data from an upstream bus node (bus node 160) on bus 162, and selects bus node 160's data or cache line buffer 145's data using multiplexer 165. In turn, multiplexer 165's output feeds into latch 170, which provides data to a downstream bus node (bus node 175). Bus node 155 also passes bus data to processing engine 100 through internal latch 180. From latch 180, bus data targeted for atomic cache 120 feeds into multiplexer 185, and bus data targeted toward local storage 110 feeds into multiplexer 130, which arbitration control 125 controls.

When processing engine 100 encounters a “GETLLAR” (get lock line and reservation) command to transfer data from a cache line located in atomic cache 120 to local storage 110, processing engine 100 utilizes internal multiplexer 130. A challenge found is that arbitration control 125 prioritizes bus data from latch 180 before cache line data from atomic cache 120. As a result, the cache line data stalls at internal multiplexer 130, waiting for bus data from multiplexer 180 to complete.

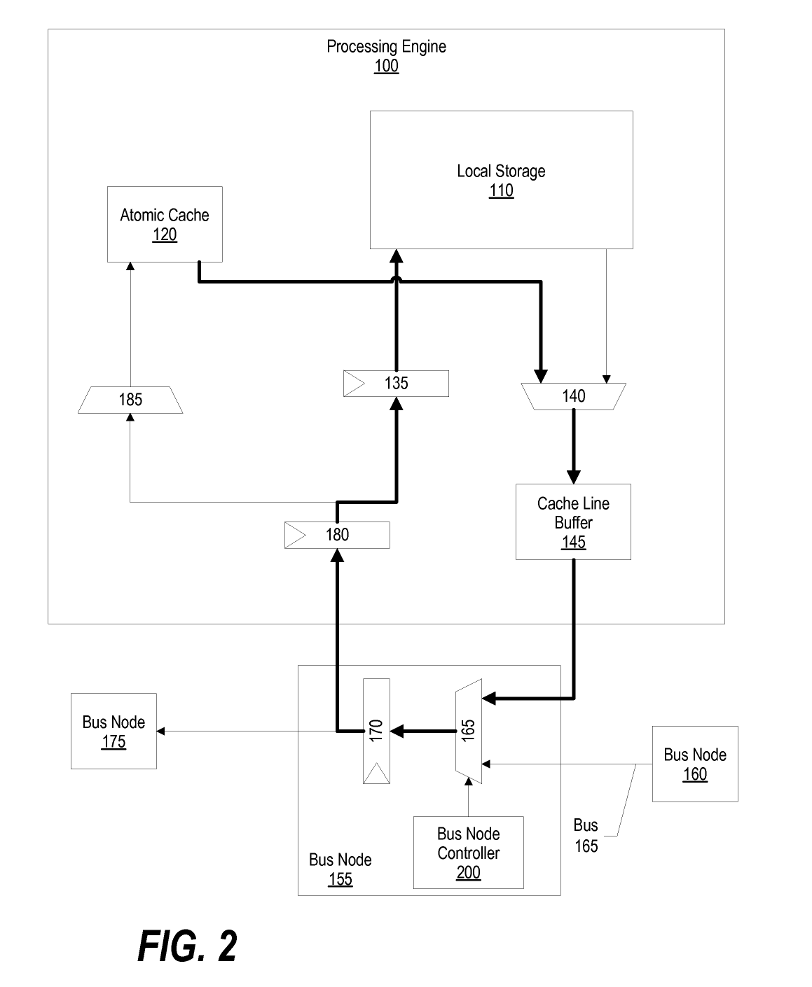

FIG. 2 is a diagram showing a processing engine using the invention described herein to transfer data from its internal atomic cache to its internal local storage area through an external bus node. Processing engine 100 includes atomic cache 120 and local storage 110, which are the same as that shown in FIG. 1. When processing engine 100 encounters a request to transfer cache line data from atomic cache 120 to local storage 110 (GETTLAR command), processing engine 100 utilizes a data-only transfer protocol to configure bus node 155 for transferring data from atomic cache 120 to local storage 110.

Processing engine 100 identifies a direct memory access (DMA) command that corresponds to a cache line located in atomic cache 120. As such, processing engine 100 sends a data request to bus node controller 200 and, in turn, bus node controller 200 sends a data grant to processing engine 100 when bus 162 is inactive. In addition, bus node controller 200 configures external multiplexer 165 to receive data from cache line buffer 145. Bus 162, external multiplexer 165, and cache line buffer 145 are the same as that shown in FIG. 1.

Processing engine 100 receives the data grant from bus node controller 200, and transfers the cache line data from atomic cache 120 through multiplexer 140 into cache line buffer 145, which feeds into external multiplexer 165. External multiplexer 165 passes the cache line data to latch 170, which feeds into bus node 175 and latch 180. From latch 180, the cache line data feeds into latch 135, which transfers the cache line data into local storage 110. Comparing FIG. 2 to FIG. 1, the invention described herein removes internal multiplexer 130 from the cache line data storage path, which previously delayed the cache line data from reaching local storage 110. Processing engine 100 uses multiplexer 185 to store data into atomic cache 120. Multiplexers 140 and 185, cache line buffer 145, and latches 170, 180, and 135 are the same as that shown in FIG. 1.

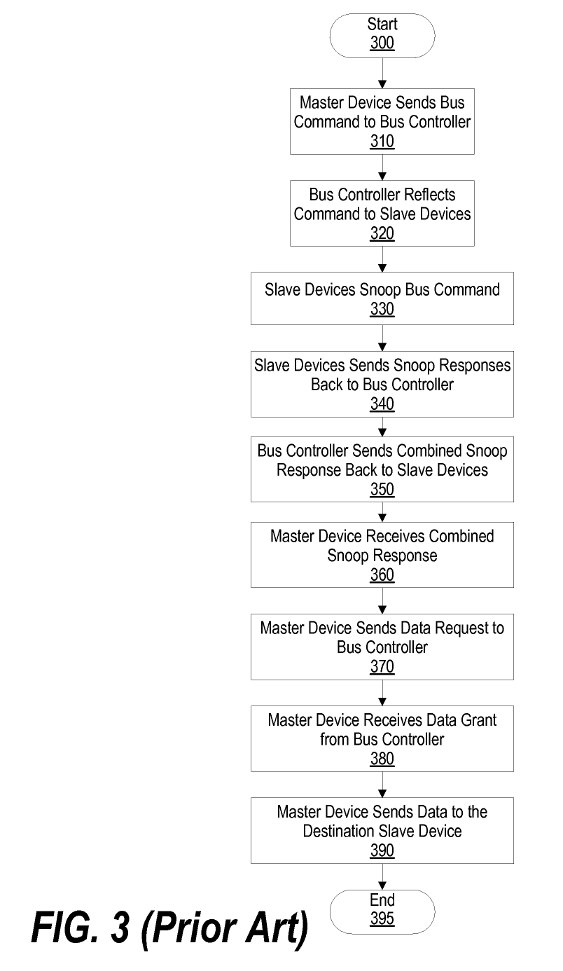

FIG. 3 is a flowchart showing steps taken in prior art proceeding through a command phase, a snoop phase, and a data phase in order for a master device to send data to a slave device without using a data-only protocol. Steps 310 through 320 comprise the command phase, steps 330 through 360 comprise the snoop phase, and steps 370 through 390 comprise the data phase.

Processing commence at 300, whereupon the master device (e.g., processing engine) sends a bus command to a bus controller at step 310. At step 320, the bus controller reflects the command to one or more slave devices. Once the command is reflected to the slave devices, the snoop phase begins at step 330, whereupon the slave devices snoop the bus command. At step 340, the slave devices send snoop responses back to the bus controller, which includes cache line status information to maintain memory coherency. The bus controller combines the snoop responses and sends the combined snoop responses to the master device at step 350, which the master device receives at step 360.

Once the master device receives the combined snoop responses, the data phase begins at step 370, whereupon the master device sends a data request to the bus controller based upon the snoop responses. At step 380, the master device receives a data grant from the bus controller, signifying approval to send data onto the bus. Once the master device receives the data grant, the master device sends the data onto the bus to the destination slave device (step 390), and processing ends at 395.

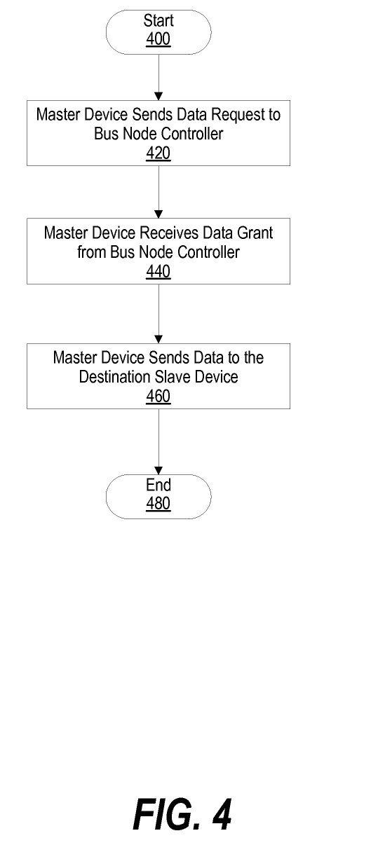

FIG. 4 is a flowchart showing steps taken in a master device sending data to itself through a bus node using a data-only protocol. FIG. 4 is different than FIG. 3 in that FIG. 4 does not include command phase steps and snoop phase steps prior to data phase steps because the master device only communicates with the bus node controller, and does not communicate to an entire system, when the bus master device sends data to itself.

Processing commences at 400, whereupon the master device sends a data request to the bus node controller at step 420. The data request may result from an atomic cache line request that the master device identified.

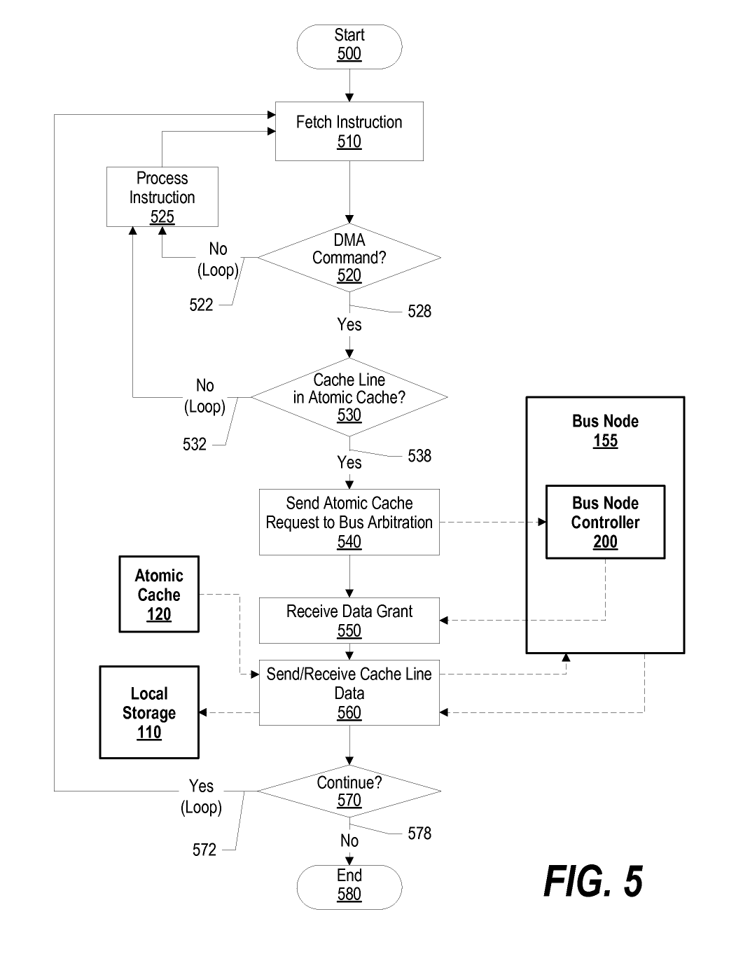

At step 440, the master device receives a data grant from the bus node controller, signifying that the bus is currently inactive (see FIG. 5 and corresponding text for further details). Once the master device receives the data grant from the bus node controller, the master device sends the data to the destination slave device through the bus node (step 460). In this case, the master device sends the data to itself through the bus node. Processing ends at 480.

FIG. 5 is a flowchart showing steps taken in a processing engine identifying an atomic cache line request and using a data-only protocol to send data to itself through a bus node.

Processing commences at 500, whereupon processing fetches an instruction from instruction memory at step 510. A determination is made as to whether the instruction is a direct memory access (DMA) instruction (decision 520). If the instruction is not a DMA instruction, decision 520 branches to “No” branch 522, which loops back to process (step 525) and fetch another instruction. This looping continues until the fetched instruction is a DMA instruction, at which point decision 520 branches to “Yes” branch 528.

A determination is made as to whether the DMA instruction corresponds to a cache line included in atomic cache, such as a “GETLLAR” command (decision 530). If the DMA command does not correspond to an atomic cache line, decision 530 branches to “No” branch 532, which loops back to process (step 525) and fetch another instruction. This looping continues until processing fetches a DMA command that requests data from an atomic cache line, at which point decision 530 branches to “Yes” branch 538.

Processing sends a data request to bus node controller 200 included in bus node 155 at step 540. At step 550, processing receives a data grant from bus node controller 200, signifying the bus is inactive. Bus node 155 is the same as that shown in FIG. 1, and bus node controller 200 is the same as that shown in FIG. 2.

Once processing receives the data grant, processing sends data from atomic cache 120 to bus node 155, and receives the data from bus node 155 and stores the data in local storage 110 (step 560) (see FIG. 2 and corresponding text for further details). A determination is made as to whether to continue processing (decision 570). If processing should continue, decision 570 branches to “Yes” branch 572, which loops back to process more instructions. This looping continues until processing should terminate, at which point decision 570 branches to “No” branch 578 whereupon processing ends at 580. Atomic cache 120 and local store 110 are the same as that shown in FIG. 1.

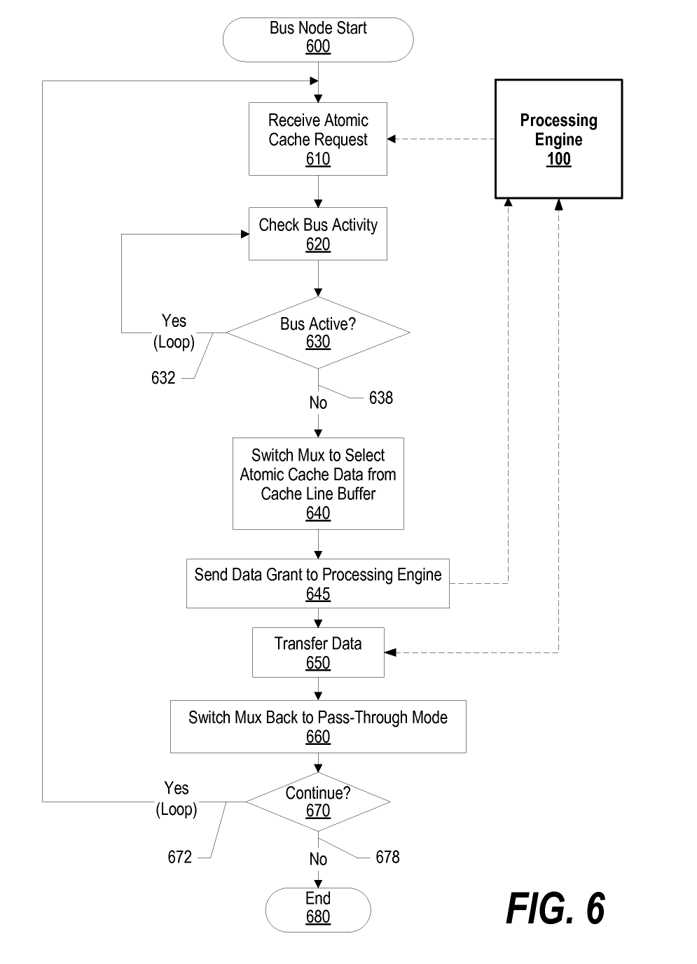

FIG. 6 is a flowchart showing steps taken in a bus node receiving data from a processing engine and sending the data back to the processing engine using a data-only protocol. Processing commences at 600, whereupon processing receives a data request from processing engine 100 at step 610. Processing engine 100 is the same as that shown in FIG. 1.

Processing checks bus activity at step 620, and a determination is made as to whether the bus is active (decision 630). If the bus is active, decision 630 branches to “Yes” branch 632, which loops back to continue to check the bus activity. This looping continues until the bus is inactive, at which point decision 630 branches to “No ” branch 638 whereupon processing switches an external bus multiplexer to select, as its input, cache line data from the atomic cache included in processing engine 100 (step 640). At step 645, processing sends a data grant to processing engine 100, informing processing engine 100 to send the cache line data.

At step 650, processing engine sends the cache line data to the bus node, which the bus node sends back to processing engine 100 to store in a local storage area (see FIGS. 2, 5, and corresponding text for further details). Once the data transfer is complete, processing switches the bus multiplexer back to pass-through mode to pass bus data through (step 660). A determination is made as to whether to continue processing requests (decision 670). If processing should continue processing requests, decision 670 branches to “Yes” branch 672, which loops back to process more requests. This looping continues until processing should terminate, at which point decision 670 branches to “No” branch 678 whereupon processing ends at 680.

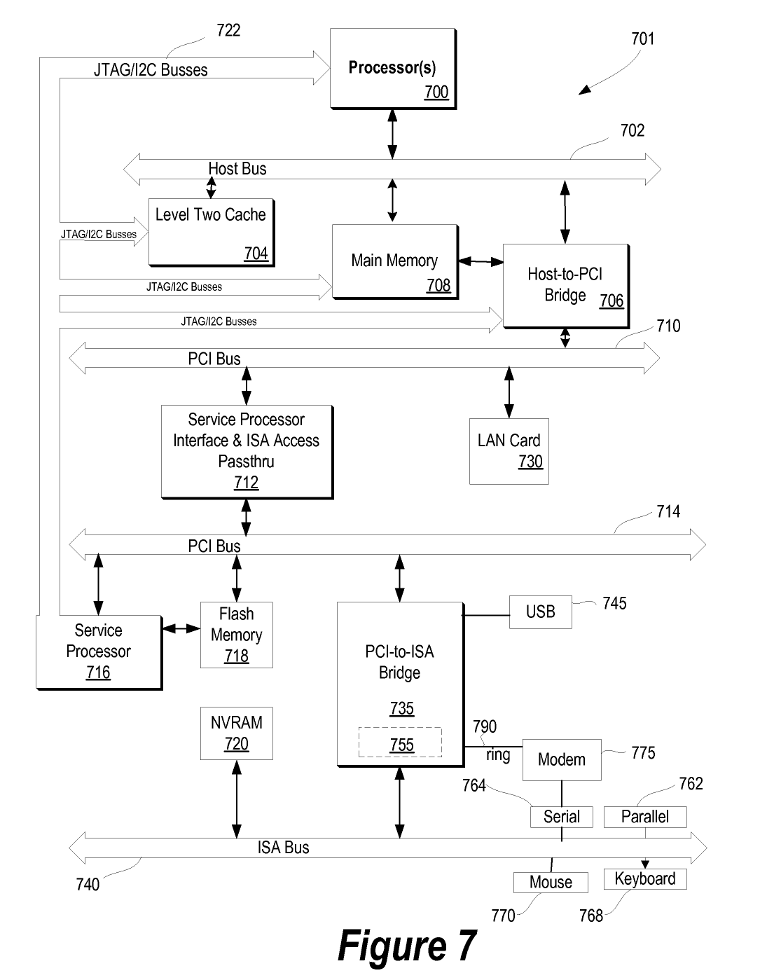

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

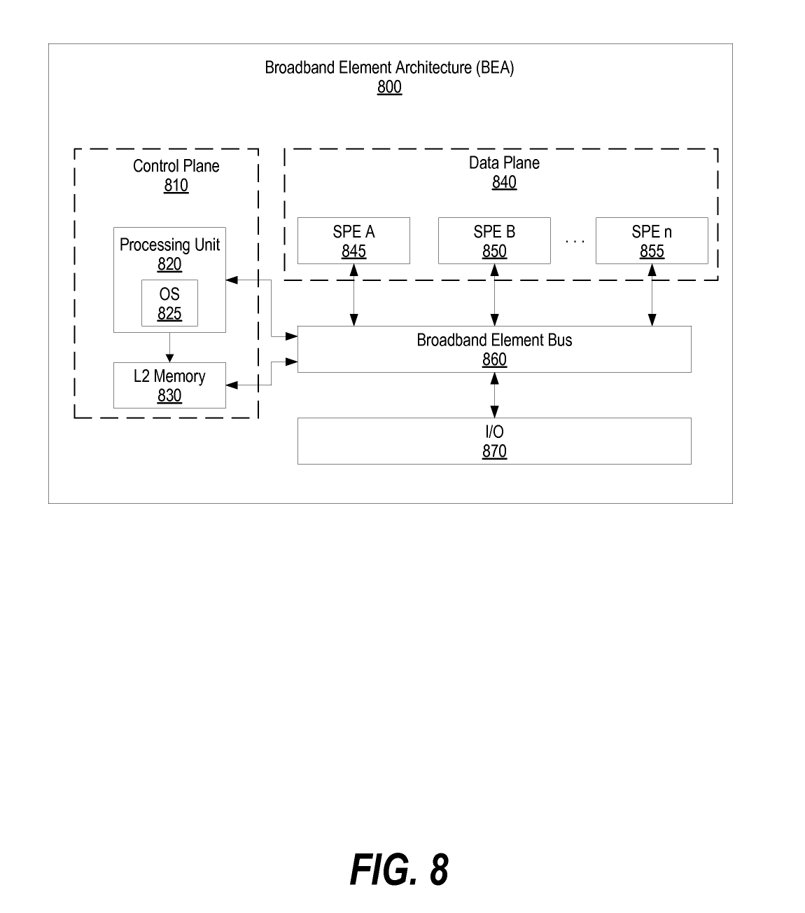

FIG. 8 is a diagram showing a broadband element architecture which includes a plurality of heterogeneous processors capable of implementing the invention described herein. The heterogeneous processors share a common memory and a common bus. Broadband element architecture (BEA) 800 sends and receives information to/from external devices through input output 870, and distributes the information to control plane 810 and data plane 840 using processor element bus 860. Control plane 810 manages BEA 800 and distributes work to data plane 840.

Control plane 810 includes processing unit 820 which runs operating system (OS) 825. For example, processing unit 820 may be a Power PC core that is embedded in BEA 800 and OS 825 may be a Linux operating system. Processing unit 820 manages a common memory map table for BEA 800. The memory map table corresponds to memory locations included in BEA 800, such as L2 memory 830 as well as non-private memory included in data plane 840.

Data plane 840 includes Synergistic processing element's (SPE) 845, 850, and 855. Each SPE is used to process data information and each SPE may have different instruction sets. For example, BEA 800 may be used in a wireless communications system and each SPE may be responsible for separate processing tasks, such as modulation, chip rate processing, encoding, and network interfacing. In another example, each SPE may have identical instruction sets and may be used in parallel to perform operations benefiting from parallel processes. Each SPE includes a synergistic processing unit (SPU) which is a processing core, such as a digital signal processor, a microcontroller, a microprocessor, or a combination of these cores.

SPE 845, 850, and 855 are connected to processor element bus 860, which passes information between control plane 810, data plane 840, and input/output 870. Bus 860 is an on-chip coherent multi-processor bus that passes information between I/O 870, control plane 810, and data plane 840. Input/output 870 includes flexible input-output logic which dynamically assigns interface pins to input output controllers based upon peripheral devices that are connected to BEA 800.

While FIGS. 7 and 8 show two information handling systems, the information handling system may take many forms. For example, information handling system 701 may take the form of a desktop, server, portable, laptop, notebook, or other form factor computer or data processing system. Information handling system 701 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a direct memory access command;
determining that the direct memory access command corresponds to an atomic cache line that is located within a processing engine;
in response to determining that the direct memory access command corresponds to the atomic cache line, configuring a bus node located external to the processing engine to receive cache line data from the atomic cache line using a data-only transfer protocol;
sending the cache line data from the processing engine to the bus node using the data-only transfer protocol, wherein the bus node sends the cache line data back to the processing engine; and
in response to receiving the cache line data from the bus node, storing the cache line data in a local storage area located in the processing engine.

2. The method of claim 1 wherein the data-only transfer protocol executes a data phase without prior execution of a command phase or a snoop phase.

3. The method of claim 2 wherein the data phase further comprises:
sending an atomic cache line request to a bus node controller that corresponds to the bus node;
receiving a data grant from the bus node controller at the processing engine; and
performing the sending of the cache line data from the processing engine to the bus node after receiving the data grant.

4. The method of claim 3 further comprising:
checking bus activity on an external broadband data bus at the bus node;
determining that the external broadband data bus is inactive; and
sending the data grant from the bus node to the processing engine in response to determining that the external broadband data bus is inactive.

5. The method of claim 4 further comprising:
detecting that the cache line data is finished being sent from the bus node to the processing engine; and
in response to detecting that the cache line data is finished being sent from the bus node to the processing engine, configuring the bus node to a pass-through mode that accepts the bus activity from the external broadband data bus.

6. The method of claim 1 wherein direct memory access command is a get lock line and reservation command.

7. The method of claim 1 wherein the method includes a processing unit and the processing engine is a synergistic processing engine, and wherein the processing unit includes an operating system that controls the synergistic processing engine.

8. A computer program product stored on a computer operable media, the computer operable media containing instructions for execution by a computer, which, when executed by the computer, cause the computer to implement a method of processing a direct memory access request, the method comprising:
receiving a direct memory access command;
determining that the direct memory access command corresponds to an atomic cache line that is located within a processing engine;
in response to determining that the direct memory access command corresponds to the atomic cache line, configuring a bus node located external to the processing engine to receive cache line data from the atomic cache line using a data-only transfer protocol;
sending the cache line data from the processing engine to the bus node using the data-only transfer protocol, wherein the bus node sends the cache line data back to the processing engine; and
in response to receiving the cache line data from the bus node, storing the cache line data in a local storage area located in the processing engine.

9. The computer program product of claim 8 wherein the data-only transfer protocol executes a data phase without prior execution of a command phase or a snoop phase.

10. The computer program product of claim 9 wherein the method further comprises:
sending an atomic cache line request to a bus node controller that corresponds to the bus node;
receiving a data grant from the bus node controller at the processing engine; and
performing the sending of the cache line data from the processing engine to the bus node after receiving the data grant.

11. The computer program product of claim 10 wherein the method further comprises:
checking bus activity on an external broadband data bus at the bus node;
determining that the external broadband data bus is inactive; and
sending the data grant from the bus node to the processing engine in response to determining that the external broadband data bus is inactive.

12. The computer program product of claim 11 wherein the method further comprises:
detecting that the cache line data is finished being sent from the bus node to the processing engine; and
in response to detecting that the cache line data is finished being sent from the bus node to the processing engine, configuring the bus node to a pass-through mode that accepts the bus activity from the external broadband data bus.

13. The computer program product of claim 8 wherein direct memory access command is a get lock line and reservation command.

14. The computer program product of claim 8 wherein the method includes a processing unit and the processing engine is a synergistic processing engine, and wherein the processing unit includes an operating system that controls the synergistic processing engine.

15. An information handling system comprising:
one or more processors;
a memory accessible by the processors;
one or more nonvolatile storage devices accessible by the processors; and
a set of instructions stored in the memory of one of the processors, wherein one or more of the processors executes the set of instructions in order to perform actions of:
receiving a direct memory access command;
determining that the direct memory access command corresponds to an atomic cache line that is located within a processing engine;
in response to determining that the direct memory access command corresponds to the atomic cache line, configuring a bus node located external to the processing engine to receive cache line data from the atomic cache line using a data-only transfer protocol;
sending the cache line data from the processing engine to the bus node using the data-only transfer protocol, wherein the bus node sends the cache line data back to the processing engine; and
in response to receiving the cache line data from the bus node, storing the cache line data in a local storage area located in the processing engine.

16. The information handling system of claim 15 wherein the data-only transfer protocol executes a data phase without prior execution of a command phase or a snoop phase.

17. The information handling system of claim 16 further comprising an additional set of instructions in order to perform actions of:
sending an atomic cache line request to a bus node controller that corresponds to the bus node;
receiving a data grant from the bus node controller at the processing engine; and
performing the sending of the cache line data from the processing engine to the bus node after receiving the data grant.

18. The information handling system of claim 17 further comprising an additional set of instructions in order to perform actions of:
checking bus activity on an external broadband data bus at the bus node;
determining that the external broadband data bus is inactive; and
sending the data grant from the bus node to the processing engine in response to determining that the external broadband data bus is inactive.

19. The information handling system of claim 18 further comprising an additional set of instructions in order to perform actions of:
detecting that the cache line data is finished being sent from the bus node to the processing engine; and
in response to detecting that the cache line data is finished being sent from the bus node to the processing engine, configuring the bus node to a pass-through mode that accepts the bus activity from the external broadband data bus.

20. The information handling system of claim 15 wherein direct memory access command is a get lock line and reservation command.
